(19) United States
(12) Patent Application Publication
(10) Pub. No.: US 2014/0177161 A1
(43) Pub. Date: Jun. 26, 2014

(54) EXPANSION APPARATUS WITH NETWORK MODULE

(71) Applicant: Nai-Chien CHANG, New Taipei City (TW)

(72) Inventor: Nai-Chien CHANG, New Taipei City (TW)

(21) Appl. No.: 14/093,519

(22) Filed: Dec. 2, 2013

(30) Foreign Application Priority Data
Dec. 25, 2012 (TW) 101225092

(51) Int. Cl. G06F 1/16

(52) U.S. Cl. CPC G06F 1/1613
USPC 361/679.32

(57) ABSTRACT

An expansion apparatus with a network module mainly has a circuit board, and a signal output port, a central processing unit, a memory unit, and a network module which are electrically connected on the circuit board. The memory unit stores an operating system, and the operating system is executed by the central processing unit after the expansion apparatus is started up. The expansion apparatus is substantially a small computer. The signal output port is provided to connect to an external display screen to output video and audio signals generated by executing the operating system to the display screen and displayed on the display screen. The network module is electrically connected to the central processing unit to provide 3G, 3.5G, or 4G-LET network connection functions. Accordingly, the expansion apparatus is used to be a small computer with a network connection function.

### BACKGROUND

1. Technical Field

The present disclosure relates generally to an expansion apparatus, and more particularly to an expansion apparatus with a network module providing the network function.

2. Description of Related Art

For many years, the computer is very popular, and even almost each family has at least one computer. For the traditional personal computer, the mother board, the central processing unit (CPU), the random access memory (RAM), the graphic card, the sound card, the heat-dissipating fan, and a plurality of connector are necessary to be installed inside to the traditional PC. Also the outer casing, it is difficult to move and even carry the traditional PC because of a large volume of the traditional PC.

With the breakthrough and development of manufacturing process in the semiconductor industry, the volume of all kinds of electronic components gets smaller and the efficiency thereof gets greater in recent years. Take the PC for an example, the components such as the mother board, the CPU, the memory are improved and designed to get smaller volume, greater efficiency, and better heat dissipation. In addition, the graphic card and the sound card are also directly built in the mother board. Therefore, the concept of mini computer is appeared on the market.

In recent years, it is prosperous to the free license for the operating system, such as Android operating system and Linus operating system so that the users pay nothing in copyright fees. In addition, the Android operating system and Linus operating system are applied to the mini computers because they have lower hardware requirements. Accordingly, the mini computers are cheaper and smaller due to the hardware limitations.

The major advantage of the mini computer is small size because of reduction in size of the computer hardware so that it is easy to carry and used anywhere for the user. However, the existing mini computers do not the network connection function so that the practicality of the mini computer is significantly decreased.

### SUMMARY

An object of the present disclosure is to provide an expansion apparatus with a network module; the expansion apparatus is operated to be a small computer by executing an operating system therein and the network module is used to provide a network connection function.

In order to achieve the above object, an expansion apparatus with a network module configured to electrically connect to an external display screen. The expansion apparatus comprises:

a circuit board;

a memory unit electrically connected on the circuit board, and the memory unit configured to store an operating system;

a central processing unit electrically connected on the circuit board and electrically connected to the memory unit, and the central processing unit configured to execute the operating system after the expansion apparatus is started up;

a signal output port electrically connected on the circuit board and electrically connected to the central processing unit, and the expansion apparatus electrically connected to the display screen through the signal output port and configured to output video and audio signals generated by executing the operating system;

a first connector electrically connected on the circuit board and electrically connected to the central processing unit, and the expansion apparatus connected to an external power source through the first connector and the power source configured to provide the required power to the expansion apparatus;

a second connector electrically connected on the circuit board and electrically connected to the central processing unit, and the expansion apparatus connected to an external input device through the second connector and the input device configured to operate the operating system executed in the expansion apparatus;

a network module electrically connected on the circuit board and electrically connected to the central processing unit, and the network module configured to provide a network function of 3G, 3.5G, or 4G-LTE mobile communication;

an antenna unit electrically connected on the circuit board and electrically connected to the network module; and

a switch unit electrically connected on the circuit board and electrically connected to the central processing unit, and the switch unit configured to be externally triggered to start up the expansion apparatus.

The signal output port is a high definition multimedia interface connector (HDMI connector) and the second connector is a USB connector.

The first connector is a micro USB connector or a mini USB connector.

The expansion apparatus further comprises a battery unit, the battery unit is electrically connected on the circuit board and electrically connected to the central processing unit, and the battery unit is configured to be charged by the external power source to supply power to the expansion apparatus.

The expansion apparatus further comprises a wireless transmission unit, the wireless transmission unit is electrically connected on the circuit board and electrically connected to the central processing unit, and the expansion apparatus configured to connect to an external peripheral device through the wireless transmission unit; wherein the wireless transmission unit is a Bluetooth transmission unit, a RF transmission unit, an infrared transmission unit, or a Wi-Fi Direct transmission unit.

In order to achieve the above object, an expansion apparatus with a network module configured to electrically connect to an external display screen. The expansion apparatus comprises:

a circuit board;

a memory unit electrically connected on the circuit board, and the memory unit configured to store an operating system;

a central processing unit electrically connected on the circuit board and electrically connected to the memory unit, and the central processing unit configured to execute the operating system after the expansion apparatus is started up;

a signal output port electrically connected on the circuit board and electrically connected to the central processing unit, and the expansion apparatus electrically connected to the display screen through the signal output port and configured to output video and audio signals generated by executing the operating system;

a first connector electrically connected on the circuit board and electrically connected to the central processing unit, and the expansion apparatus connected to an external power source through the first connector and the power source configured to provide the required power to the expansion apparatus;

a second connector electrically connected on the circuit board and electrically connected to the central processing unit, and the expansion apparatus connected to an external input device through the second connector and the input device configured to operate the operating system executed in the expansion apparatus;

a SIM card slot electrically connected on the circuit board and electrically connected to the central processing unit, and the SIM card slot configured to be inserted by an external SIM card; wherein the SIM card is configured to provide a 3G, 3.5G, or 4G-LTE network connection function;

a network processing unit electrically connected on the circuit board and electrically connected to the SIM card slot, and the network processing unit configured to process the 3G, 3.5G, or 4G-LET network signals generated from the SIM card;

an antenna unit electrically connected on the circuit board and electrically connected to the network processing unit; and

a switch unit electrically connected on the circuit board and electrically connected to the central processing unit, and the switch unit configured to be externally triggered to start up the expansion apparatus.

The signal output port is a high definition multimedia interface connector (HDMI connector) and the second connector is a USB connector.

The first connector is a micro USB connector or a mini USB connector.

The expansion apparatus further comprises a battery unit, the battery unit is electrically connected on the circuit board and electrically connected to the central processing unit, and the battery unit is configured to be charged by the external power source to supply power to the expansion apparatus.

The expansion apparatus further comprises a wireless transmission unit, the wireless transmission unit is electrically connected on the circuit board and electrically connected to the central processing unit, and the expansion apparatus configured to connect to an external peripheral device through the wireless transmission unit; wherein the wireless transmission unit is a Bluetooth transmission unit, a RF transmission unit, an infrared transmission unit, or a Wi-Fi Direct transmission unit.

Comparing to the prior art, the present disclosure provides an expansion apparatus with a network module and the expansion apparatus is substantially a small computer without a display screen. Also, the expansion apparatus is connected to an external display screen through the signal output port so that the video and audio signals generated by executing the operating system are transmitted to the display screen and displayed on the display screen. Accordingly, it is convenient for the user to carry the expansion apparatus and use the expansion apparatus anywhere. In addition, the network module provides the network module to connect to the Internet based on the 3G, 3.5G, or 4G-LTE mobile communication. Accordingly, the user can use the expansion apparatus to connect to the display screen so that the expansion apparatus is substantially a small computer with the network connection function.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a perspective exploded view of an expansion apparatus with a network module according to a first preferred embodiment of the present disclosure;

FIG. 2 is a perspective assembled view of the expansion apparatus with the network module according to the first preferred embodiment of the present disclosure;

FIG. 3 is a block diagram of the expansion apparatus with the network module according to the first preferred embodiment of the present disclosure;

FIG. 4 is a schematic view of using the expansion apparatus with the network module according to the first preferred embodiment of the present disclosure;

FIG. 5 is a perspective exploded view of the expansion apparatus with the network module according to a second preferred embodiment of the present disclosure; and

FIG. 6 is a block diagram of the expansion apparatus with the network module according to the second preferred embodiment of the present disclosure.

### DETAILED DESCRIPTION

Reference will now be made to the drawing figures to describe the present invention in detail.

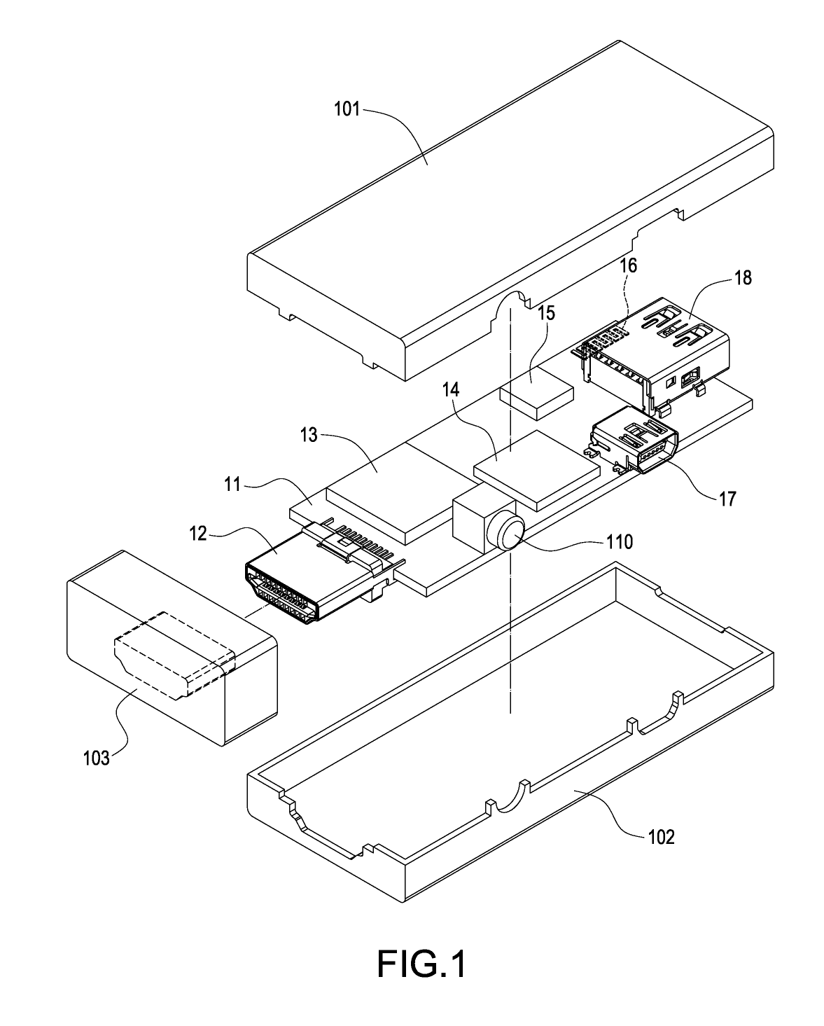

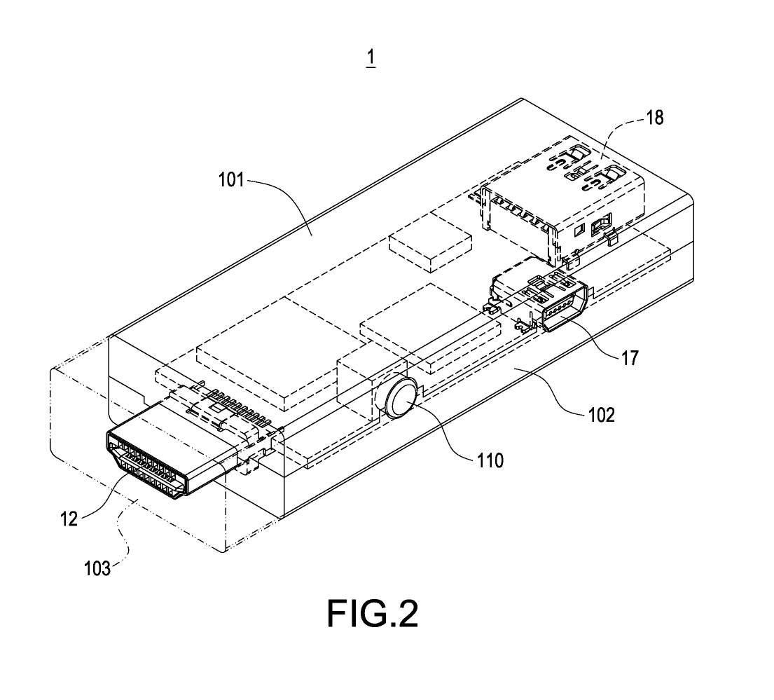

Reference is made to FIG. 1 and FIG. 2 which are a perspective exploded view and a perspective assembled view of an expansion apparatus with a network module according to a first preferred embodiment of the present disclosure, respectively. The expansion apparatus 1 is substantially a small computer without a display screen. Also, the expansion apparatus 1 has the features of small size and easy to carry. As shown in FIG. 1, the expansion apparatus 1 mainly includes a circuit board 11, and a signal output port 12, a central processing unit (CPU) 13, a memory unit 14, a network module 15, an antenna unit 16, a first connector 17, a second connector 18, and a switch unit 110 which are electrically connected on the circuit board 11. The expansion apparatus 1 further has an upper cover 101 and a lower cover 102 correspondingly arranged to the upper cover 101, and the upper cover 101 and the lower cover 102 are combined to cover the circuit board 11 and the components electrically connected on the circuit board 11.

In this embodiment, the signal output port 12 is a male connector, and the signal output port 12 is protruded at one side of the upper cover 101 and the lower cover 102. The expansion apparatus 1 can be electrically connected to the external display screen through the signal output port 12 so that signals of the expansion apparatus 1, such as the video and audio signals are transmitted to the display screen and displayed on the display screen. As shown in FIG. 2, the expansion apparatus 1 further has a front cover 103, and the front cover 103 is provided to cover the protruded signal output port 12 so as to prevent the signal output port 12 from dust and damage.

In addition, the upper cover 101 and the lower cover 102 have a plurality of openings thereon. The first connector 17 and the second connector 18 are exposed at the openings of the upper cover 101 and/or the lower cover 102 so as to connect to external devices by connecting transmission lines. Also, the switch unit 110 is exposed at one of the openings of the upper cover 101 and/or the lower cover 102 so as to start up the expansion apparatus 1 by externally triggering the switch unit 110 by the user.

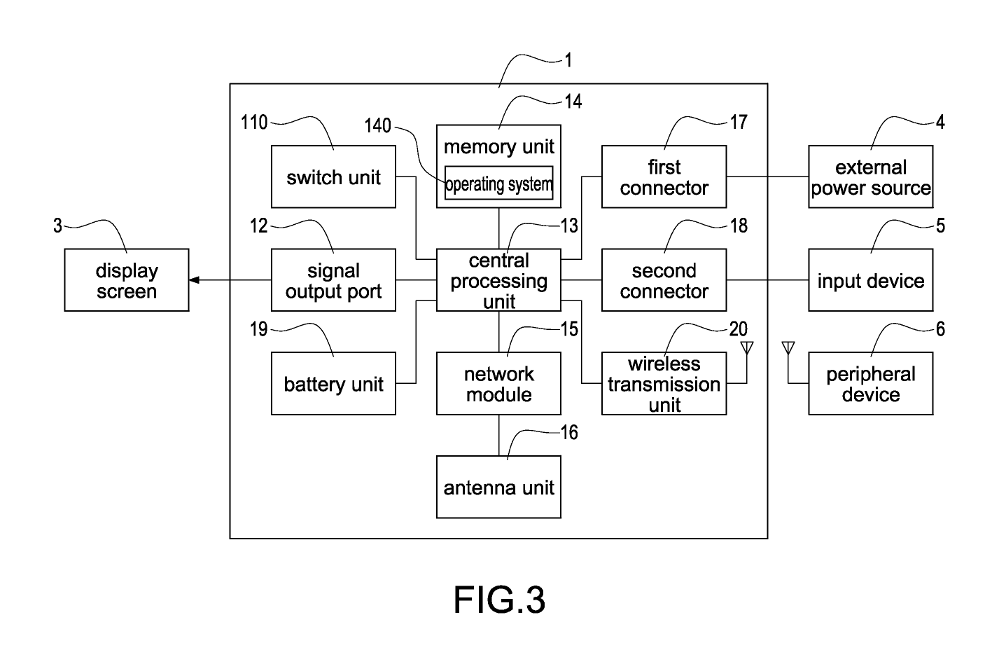

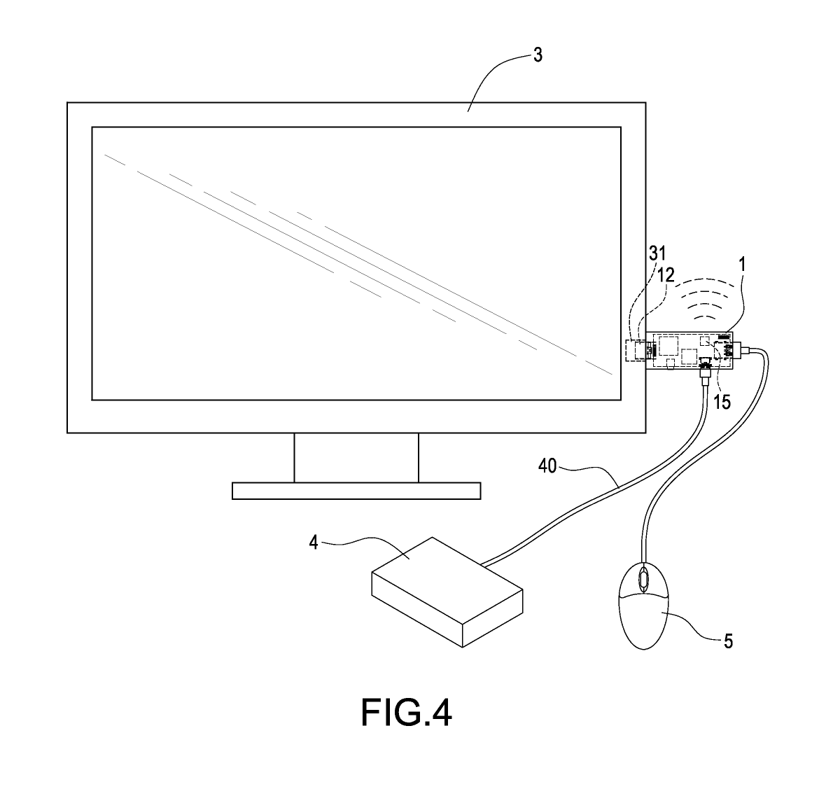

Reference is made to FIG. 3 and FIG. 4 is a block diagram of the expansion apparatus with the network module and a schematic view of using the expansion apparatus with the network module according to the first preferred embodiment of the present disclosure, respectively. The memory unit 14 is electrically connected to the CPU 13 through the circuit board 11, and the memory unit 14 is provided to store at least one operating system (OS) 140. The CPU 13 executes the operating system 140 in the memory unit 14 when the expansion apparatus 1 is started up; that is, the expansion apparatus 1 can be regarded as the small computer. The switch unit 110 is electrically connected to the CPU 13 through the circuit board 11, and the expansion apparatus 1 is started up when the switch unit 110 is externally triggered so that the operating system 140 is executed by the CPU 13.

The signal output port 12 is electrically connected to the CPU 13 through the circuit board 11, and the expansion apparatus 1 can be connected to an external display screen 3 through the signal output port 12 so that the video and audio signals generated by executing the operating system 140 are transmitted to the display screen 3 and displayed on the display screen 3. In this embodiment, the signal output port 12 is a high definition multimedia interface connector (HDMI connector). More specifically, the signal output port 12 is a male HDMI connector, and the male HDMI connector is inserted into a female HDMI connector 31 installed at the display screen 3. However, the embodiment is only exemplified but is not intended to limit the scope of the disclosure.

The first connector 17 is electrically connected to the CPU 13 through the circuit board 11. In this embodiment, the first connector 17 is used to electrically connect to an external power source 4 to receive the required power for supplying the expansion apparatus 1. In this embodiment, the first connector 17 is a mini USB connector or a micro USB connector. The first connector 17 is connected to external transmission line 40 and connected to the external power source 4 through the transmission line 40 to receive the power generated from the external power source 4. As shown in FIG. 3, the expansion apparatus 1 further has an optional battery unit 19. The battery unit 19 is electrically connected on the circuit board 11 and electrically connected to the CPU 13 through the circuit board 11. When the expansion apparatus 1 receives the required power supplied from the external power source 4 through the first connector 17, the battery unit 19 can be simultaneously charged. Accordingly, the battery unit 19 can be used to provide the required power to the expansion apparatus 1 to maintain normal operations of the expansion apparatus 1 if the expansion apparatus 1 is disconnected to the external power source 4. However, the embodiment is only exemplified but is not intended to limit the scope of the disclosure.

As mentioned above, the expansion apparatus 1 is substantially a small computer without a display screen. Also, the expansion apparatus 1 does not provide any built-in input devices for operating the operating system 140. The second connector 18 is electrically connected to the CPU 13 through the circuit board 11, and the expansion apparatus 1 is connected to an external input device 5, such as a keyboard, a mouse, a touchpad, or a trackball. In FIG. 4, the mouse is exemplified as the input device 5, but not limited. When the expansion apparatus 1 is started up and connected to the input device 5 through the second connector 18, the user can operate the expansion apparatus 1 by using the input device 5. More specifically, the operating system 140 is executed by operating the expansion apparatus 1. In this embodiment, the second connector 18 is a USB connector. However, the embodiment is only exemplified but is not intended to limit the scope of the disclosure.

The network module 15 is electrically connected to the CPU 13 through the circuit board 11, and the network module 15 can provide a connection function of the third generation (3G) mobile communication. More specifically, the network module 15 has a 3G network chip (not shown) so that the user can operate the expansion apparatus 1 to connect to the Internet by the 3G network signals generated from the network module 15. Especially, the 3G network chip can be a SIM card with the 3G network connection function, and the 3G network chip is welded inside the network module 15 for providing the 3G network signals. However, the embodiment is only exemplified but is not intended to limit the scope of the disclosure. The antenna unit 16 is electrically connected to the network module 15 through the circuit board 11 to improve signal transmission quality of the network module 15.

Especially, the network module 15 can also provide the connection function of the 3.5G or 4G-LTE mobile communication, that is, the network module 15 has a 3.5G network chip or 4G-LTE network chip so that the user can operate the expansion apparatus 1 to connect to the Internet by the 3.5G or 4G-LTE network signals generated from the network module 15. Also, the 3.5G network chip or 4G-LTE can be a SIM card with the 3.5G or 4G-LTE network connection function, and the 3.5G network chip or the 4G-LTE network chip is welded inside the network module 15 for providing the 3.5G or 4G-LTE network signals. However, the embodiments are only exemplified but are not intended to limit the scope of the disclosure.

As shown in FIG. 3, the expansion apparatus 1 further has a wireless transmission unit 20. The wireless transmission unit 20 is electrically connected on the circuit board 11 and electrically connected to the CPU 13 through the circuit board 11. In this embodiment, the wireless transmission unit 20 is a Bluetooth transmission unit, a RF transmission unit, an infrared transmission unit, or a Wi-Fi Direct transmission unit. However, the embodiments are only exemplified but are not intended to limit the scope of the disclosure. The expansion apparatus 1 can establish a wireless connection to the peripheral device 6 through the wireless transmission unit 20. In particular, the peripheral device 6 can be a wireless keyboard, a wireless mouse, or a wireless hard disk matched to the wireless transmission unit 20. For example, if it is inconvenient to connect the second connector 18 to the input device 5 through the transmission line 40, the user can connect the wireless transmission unit 20 the wireless keyboard and/or the wireless mouse to operate the operating system executing in the expansion apparatus 1. However, the embodiment is only exemplified but is not intended to limit the scope of the disclosure.

As shown in FIG. 4, the expansion apparatus 1 is connected to a corresponding connector, such as a female HDMI connector through the signal output port 12, such as a male HDMI connector. Accordingly, the video and audio signals generated by executing the operating system are transmitted to the display screen 3 and displayed on the display screen 3 after the expansion apparatus 1 is started up.

As mentioned above, the first connector 17 is connected to external transmission line 40 and connected to the external power source 4 through the transmission line 40 to receive the power generated from the external power source 4 for supplying the expansion apparatus 1 or charging the battery unit 19. The expansion apparatus 1 is further connected to the input device 5 through the second connector 18 so that the user can operate the expansion apparatus 1 by using the input device 5. In addition, the user can operate the expansion apparatus 1 to connect to the Internet by the built-in network module 15. More specifically, the expansion apparatus 1 is operated to be a small computer with the network connection function by the 3G, 3.5G or 4G-LTE network signals.

As mentioned above, the user can see the execution results generated by executing the operating system 140 including the video signals and audio signals on the display screen 3. For example, when the operating system 140 is an Android operating system which is operated inside the expansion apparatus 1, the user can operate the expansion apparatus 1 through the input device 5 or the peripheral device 6 to connect to the Internet through the network module 15. Accordingly, the user can login an online shopping system based on the Android operating system, such as Google Play to download free or paid Apps. After the App is installed and executed in the expansion apparatus 1, the generated video and audio signals are transmitted to the display screen 3 and displayed on the display screen 3.

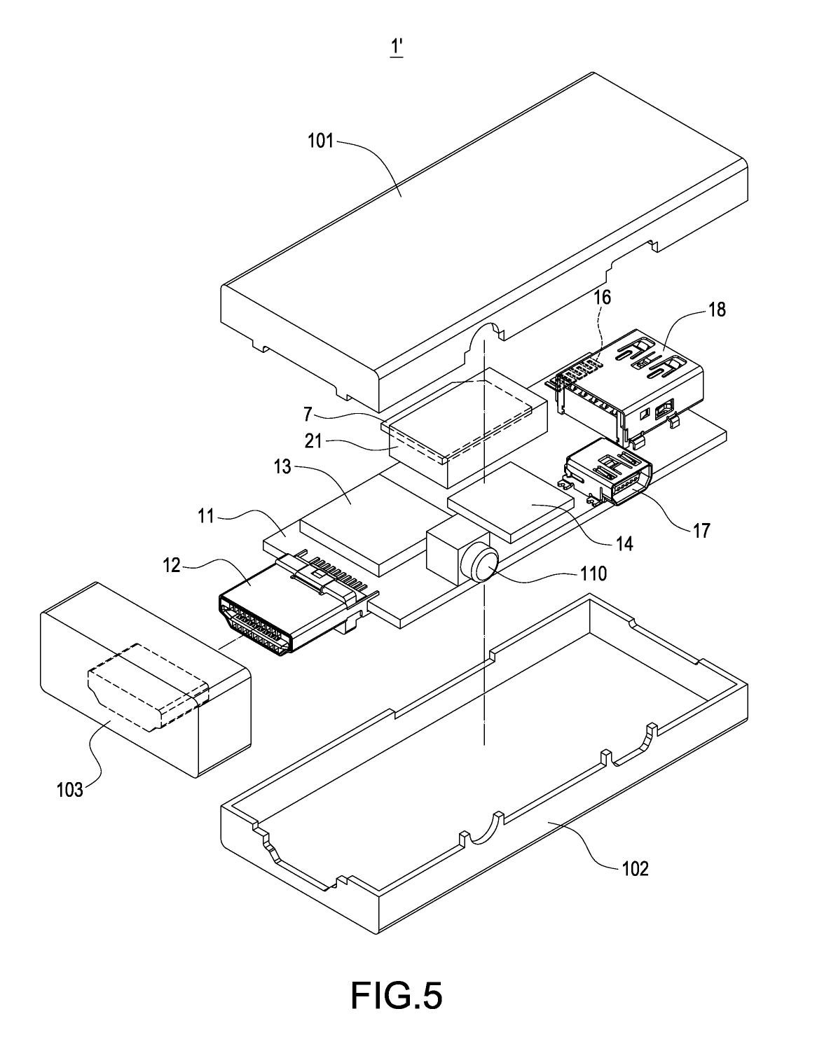

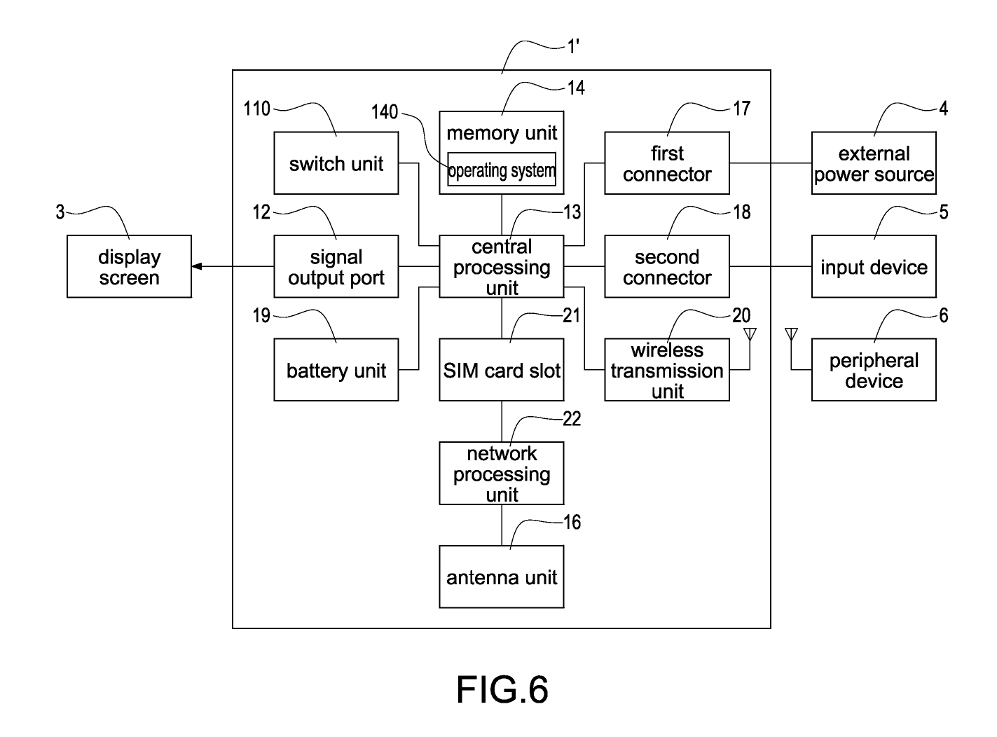

Reference is made to FIG. 5 and FIG. 6 which are a perspective exploded view and a block diagram of the expansion apparatus with the network module according to a second preferred embodiment of the present disclosure. The present disclosure discloses another expansion apparatus 1′. The major difference between the expansion apparatus 1′ and the expansion apparatus 1 is that the expansion apparatus 1′ has a SIM card slot 21 and a network processing unit 22 instead of the network module 15. The SIM card slot 21 and the network processing unit 22 are electrically connected on the circuit board 11. The SIM card slot 21 is electrically connected to the CPU 13 through the circuit board 11 and the network processing unit 22 is electrically connected to the SIM card slot 21 through the circuit board 11. The antenna unit 16 is still provided in the expansion apparatus 1′ and electrically connected to the network processing unit 22 through the circuit board 11.

As shown in FIG. 5, the SIM card slot 21 is protruded and exposed at one of the openings of the upper cover 101 and/or the lower cover 102. Also, an external SIM card 7 with the 3G network connection function is inserted in the SIM card slot 21. The network processing unit 22 is electrically connected to the SIM card slot 21 to process the 3G network signals generated from the SIM card 7, and the antenna unit 16 is provided to improve signal transmission quality of the network processing unit 22. When the SIM card 7 is inserted in the SIM card slot 21 and the expansion apparatus 1′ is started up to detect and capture the 3G network signal, the user can operate the expansion apparatus 1′ to connect to the Internet through the SIM card 7. In other words, the above-mentioned network module 15 in the first embodiment is equivalent to a combination of the SIM card 7, the SIM card slot 21, and the network processing unit 22.

Especially, the network processing unit 22 can be replaced by a 3.5G and/or a 4G-LTE network processing unit. When the SIM card 7 with the 3.5G or 4G-LTE network connection function is inserted into the SIM card slot 21, the 3.5G and/or a 4G-LTE network processing unit is provided to process the 3.5G or 4G-LET network signals generated from the SIM card 7, and the antenna unit 16 is provided to improve signal transmission quality of the network processing unit 22. However, the embodiments are only exemplified but are not intended to limit the scope of the disclosure.

When the expansion apparatus 1, 1′ is connected to the display screen 3 and the switch unit 110 is externally triggered to start up the expansion apparatus 1, 1′, the user can operate the expansion apparatus 1, 1′ to connect to the Internet through the network module 15 or the SIM card 7. Also, the user can operate the expansion apparatus 1, 1′ through the input device 5 or the peripheral device 6 and the generated video and audio signals are transmitted to the display screen 3 and displayed on the display screen 3.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. An expansion apparatus with a network module configured to electrically connect to an external display screen, the expansion apparatus comprising:
a circuit board;
a memory unit electrically connected on the circuit board, and the memory unit configured to store an operating system;
a central processing unit electrically connected on the circuit board and electrically connected to the memory unit, and the central processing unit configured to execute the operating system after the expansion apparatus is started up;
a signal output port electrically connected on the circuit board and electrically connected to the central processing unit, and the expansion apparatus electrically connected to the display screen through the signal output port and configured to output video and audio signals generated by executing the operating system;
a first connector electrically connected on the circuit board and electrically connected to the central processing unit, and the expansion apparatus connected to an external power source through the first connector and the power source configured to provide the required power to the expansion apparatus;
a second connector electrically connected on the circuit board and electrically connected to the central processing unit, and the expansion apparatus connected to an external input device through the second connector and the input device configured to operate the operating system executed in the expansion apparatus;
a network module electrically connected on the circuit board and electrically connected to the central processing unit, and the network module configured to provide a network function of 3G, 3.5G, or 4G-LTE mobile communication;
an antenna unit electrically connected on the circuit board and electrically connected to the network module; and
a switch unit electrically connected on the circuit board and electrically connected to the central processing unit, and the switch unit configured to be externally triggered to start up the expansion apparatus.

2. The expansion apparatus in claim 1, wherein the signal output port is a high definition multimedia interface connector (HDMI connector) and the second connector is a USB connector.

3. The expansion apparatus in claim 2, wherein the first connector is a micro USB connector or a mini USB connector.

4. The expansion apparatus in claim 2, further comprising:
a battery unit electrically connected on the circuit board and electrically connected to the central processing unit, and the battery unit configured to be charged by the external power source to supply power to the expansion apparatus.

5. The expansion apparatus in claim 2, further comprising:
a wireless transmission unit electrically connected on the circuit board and electrically connected to the central processing unit, and the expansion apparatus configured to connect to an external peripheral device through the wireless transmission unit; wherein the wireless transmission unit is a Bluetooth transmission unit, a RF transmission unit, an infrared transmission unit, or a Wi-Fi Direct transmission unit.

6. An expansion apparatus with a network module configured to electrically connect to an external display screen, the expansion apparatus comprising:
a circuit board;
a memory unit electrically connected on the circuit board, and the memory unit configured to store an operating system;
a central processing unit electrically connected on the circuit board and electrically connected to the memory unit, and the central processing unit configured to execute the operating system after the expansion apparatus is started up;
a signal output port electrically connected on the circuit board and electrically connected to the central processing unit, and the expansion apparatus electrically connected to the display screen through the signal output port and configured to output video and audio signals generated by executing the operating system;
a first connector electrically connected on the circuit board and electrically connected to the central processing unit, and the expansion apparatus connected to an external power source through the first connector and the power source configured to provide the required power to the expansion apparatus;
a second connector electrically connected on the circuit board and electrically connected to the central processing unit, and the expansion apparatus connected to an external input device through the second connector and the input device configured to operate the operating system executed in the expansion apparatus;
a SIM card slot electrically connected on the circuit board and electrically connected to the central processing unit, and the SIM card slot configured to be inserted by an external SIM card;
wherein the SIM card is configured to provide a 3G, 3.5G, or 4G-LTE network connection function;
a network processing unit electrically connected on the circuit board and electrically connected to the SIM card slot, and the network processing unit configured to process the 3G, 3.5G, or 4G-LET network signals generated from the SIM card;
an antenna unit electrically connected on the circuit board and electrically connected to the network processing unit; and
a switch unit electrically connected on the circuit board and electrically connected to the central processing unit, and the switch unit configured to be externally triggered to start up the expansion apparatus.

7. The expansion apparatus in claim 6, wherein the signal output port is a high definition multimedia interface connector (HDMI connector) and the second connector is a USB connector.

8. The expansion apparatus in claim 7, wherein the first connector is a micro USB connector or a mini USB connector.

9. The expansion apparatus in claim 7, further comprising:
a battery unit electrically connected on the circuit board and electrically connected to the central processing unit, and the battery unit configured to be charged by the external power source to supply power to the expansion apparatus.

10. The expansion apparatus in claim 7, further comprising:
a wireless transmission unit electrically connected on the circuit board and electrically connected to the central processing unit, and the expansion apparatus configured to connect to an external peripheral device through the wireless transmission unit; wherein the wireless transmission unit is a Bluetooth transmission unit, a RF transmission unit, an infrared transmission unit, or a Wi-Fi Direct transmission unit.
